(19) United States
(12) Patent Application Publication
(10) Pub. No.: US 2013/0124021 A1
(43) Pub. Date: May 16, 2013

(54) SYSTEM AND METHOD FOR CONTROLLING CREEP TORQUE OF VEHICLE

(71) Applicant: Seung Hyun Chung, Gunpo (KR)

(72) Inventor: Seung Hyun Chung, Gunpo (KR)

(73) Assignees: KIA MOTORS CORPORATION, Seoul (KR); HYUNDAI MOTOR COMPANY, Seoul (KR)

(21) Appl. No.: 13/534,741

(22) Filed: Jun. 27, 2012

(30) Foreign Application Priority Data
Nov. 14, 2011 (KR) 10-2011-0118506

(51) Int. Cl. B60W 20/00; B60W 10/08; B60W 10/06; B60W 10/18

(52) U.S. Cl. 701/22; 477/93; 477/20; 903/930

(57) ABSTRACT

A system and method for controlling creep torque of a vehicle in which a sensor detects that brakes of the vehicle are being applied and a control portion controls creep torque to be 0 once the vehicle has come to a stop, determines whether the brake is released, and sends a command to an electric motor to generate again the creep torque once the brake is released.

### CROSS-REFERENCE TO RELATED APPLICATION

This application claims priority to and the benefit of Korean Patent Application No. 10-2011-0118506 filed in the Korean Intellectual Property Office on Nov. 14, 2011, the entire contents of which are incorporated herein by reference.

### BACKGROUND OF THE INVENTION

(a) Field of the Invention

The present invention relates to a system and a method for controlling creep torque of a vehicle. More particularly, the present invention relates to a system and a method for controlling creep torque of a vehicle that reduces noise due to the creep torque when the vehicle begins to move after being stopped.

(b) Description of the Related Art

Brake noise from a braking system of a vehicle does not exert great amount of influence on driving performance of the vehicle directly, but instead typically plays a role in initial quality satisfaction for vehicle buyers. Significance of marketability and quality differentiation of vehicle manufactures is magnified in market environments where customer satisfaction is the top priority, such as the automotive industry.

Creep groan noise of brake friction members is low-frequency noise operating at about 20-200 Hz, and occurs due to a stick-slip phenomena when creep torque is greater than brake torque once a brake has been released, as shown in FIG. 1.

The stick-slip phenomena refers to when an instantaneous stick and slip occur sequentially due to a difference between a static frictional coefficient and a kinetic frictional coefficient when a friction member and a disk are rubbed together. The stick-slip changes frictional force and generates excitation force and self-excited vibration.

When the creep torque is greater than the brake torque, stick-slip occurs between a rotor of a disk brake and a brake pad at very low speeds and low pressure. Therefore, creep groan noise occurs due to self-excited vibrations.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and a method for controlling creep torque of a vehicle having advantages of reducing creep groan noise by minimizing stick-slip.

A method for controlling creep torque of a vehicle according to an exemplary embodiment of the present invention may include: stopping the vehicle via operation of a brake when the vehicle is moving; controlling, by a control portion, a creep torque to be 0 when the vehicle is stopped; determining, by the control portion, whether the brake has been released; and generating, the creep torque once the brake is released.

In some exemplary embodiments of the present invention, the method may further include operating the vehicle in a driving mode when the creep torque is generated. More specifically, the creep torque may be generated in an inversely proportional to release amount of the brake when creep torque is being generated.

The exemplary embodiment of the present invention may be implemented in an electric vehicle or a hybrid electric vehicle. In the hybrid electric vehicle, the vehicle may be operated in an electric vehicle mode while the above method is being executed. Furthermore, whether the exemplary embodiment of the present invention is implemented in an electric vehicle or a hybrid vehicle, a drive motor may be provided and the creep torque may be generated by controlling torque of the drive motor. Furthermore, operation and release of the brake may be detected by a brake pedal sensor.

A system for controlling creep torque of a vehicle according to another exemplary embodiment of the present invention may include: a sensor configured to detect an input of a brake pedal of the vehicle and deliver a signal corresponding thereto; an electric motor configured to generate the creep torque of the vehicle; and a control portion configured to receive the input signal of the brake pedal from the sensor and to control the electric motor based thereon, wherein the control portion is configured to control the creep torque to be 0 when the vehicle has stopped due to operation of a brake i once the vehicle has begun to move, and to control the electric motor to generate the creep torque once the brake is released.

The control portion may be configured to generate the creep torque in an inversely proportional to a release amount of the brake. The sensor may be a brake pedal sensor, and the vehicle may be an electric vehicle or a hybrid electric vehicle.

### BRIEF DESCRIPTION OF THE DRAWINGS

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

FIG. 1 is a graph for illustrating relation of an input of a brake pedal and creep torque of a vehicle according to a conventional art.

FIG. 2 is a block diagram of a system for controlling creep torque of a vehicle according to an exemplary embodiment of the present invention.

FIG. 3 is a flowchart of a method for controlling creep torque of a vehicle according to an exemplary embodiment of the present invention.

FIG. 4 is a graph for illustrating relation of an input of a brake pedal and creep torque in a system and a method for controlling creep torque of a vehicle according to an exemplary embodiment of the present invention.

### Description of symbols

10: system for controlling creep torque of vehicle

100: sensor (brake pedal sensor)

200: electric motor

300: control portion

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In overall specification, in addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function or operation, and can be implemented by hardware components or software components and combinations thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Exemplary embodiments of the present invention will hereinafter be described in detail with reference to the accompanying drawings.

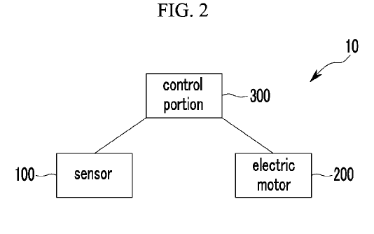

FIG. 2 is a block diagram of a system 10 for controlling creep torque of a vehicle according to an exemplary embodiment of the present invention. As shown in FIG. 2, a system 10 for controlling creep torque of vehicle according to an exemplary embodiment of the present invention includes a sensor 100 that is configured to detect an input of a brake pedal of the vehicle and deliver a signal corresponding thereto, an electric motor 200 configured to generate the creep torque of the vehicle, and a control portion 300 configured to receive the input signal of the brake pedal from the sensor 100 and control the electric motor 200 based thereon.

The sensor 100 is configured to detect the input signal of the brake of the vehicle, convert the input signal into electrical signal, and deliver the electrical signal accordingly.

In one or more exemplary embodiments, the sensor 100 may be a brake pedal sensor 100, (e.g., a brake pedal stroke sensor) which detects how much a driver pushes the brake pedal of the vehicle. The signal detected by the brake pedal sensor 100 is delivered to the control portion 300.

The electric motor 200 is used to generate the creep torque of the vehicle and is controlled by the control portion 300. Therefore, a vehicle to which the system 10 for controlling the creep torque according to an exemplary embodiment of the present invention is applied may be an electric vehicle or a hybrid electric vehicle provided with at least the electric motor 200 as power source.

Generally, the creep torque is preset according to idle RPM of an engine in a case of a vehicle with just an internal combustion engine. Since generation of the creep torque, on the contrary, is controlled by the electric motor in an electric vehicle or the hybrid electric vehicle, the system 10 for controlling the creep torque may be suitably applied to the electric vehicle or the hybrid electric vehicle.

In one or more exemplary embodiments, when the vehicle is the hybrid electric vehicle, the system 10 for controlling the creep torque is applied only during an electric vehicle mode. The electric vehicle mode is a mode where the engine is not operating and the vehicle is being driven only by the electric motor 200. When the engine is being operated in the hybrid electric vehicle, the creep torque is always generated according to the idle RPM of the engine. In this case, the system 10 for controlling the creep torque according to an exemplary embodiment of the present invention should not be used during a hybrid mode.

The control portion 300 receives an input signal from the sensor 100 that the brakes are currently being applied and controls the electric motor 200 based thereon. The control portion 300, in some illustrative embodiments of the present invention, may be an electric control unit (ECU) of the vehicle.

In further detail, the control portion 300 controls the creep torque to be 0 when the vehicle is stopped by operation of the vehicle's brakes and operates the electric motor 200 to generate a creep torque once the brake is released.

That is, stick-slip is minimized because that the control portion 300 generates the creep torque only after the brake is released, Therefore, creep groan noise may be reduced when the vehicle begins to move again.

In one or more exemplary embodiments, how much the driver pushes the brake pedal may be utilized as a threshold for whether the brakes are being applied and how much the driver releases the brake pedal may be utilized as a threshold for whether the brakes have been released and accordingly a preset for each of these thresholds may be stored in the control portion 300. That is, the brakes may be determined to be released when the signal delivered from the brake pedal sensor 100 is less than or equal to a predetermined value and the brakes may be determined to be applied when the signal delivered from the brake pedal sensor 100 is greater than the predetermined value.

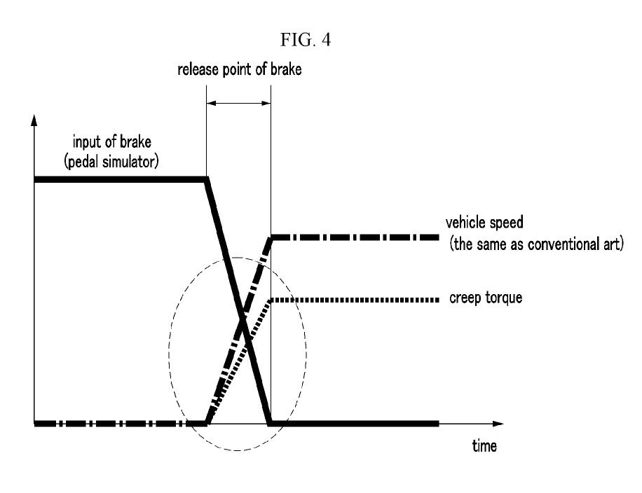

In one or more exemplary embodiments, the control portion 300 may control the electric motor 200 to generate the creep torque inversely proportional to the amount a driver has released the brake pedal, as shown in FIG. 4. Since the control portion 300 receives the input of the brake pedal from the brake pedal sensor 100 in real time, the control portion 300 controls to generate the creep torque inversely proportional to the input of the brake pedal in real time as well.

When creep torque inversely proportional to the input of the brake pedal is generated, the way a vehicle feels to a driver and driving safety of the vehicle may be improved when the vehicle begins to moves.

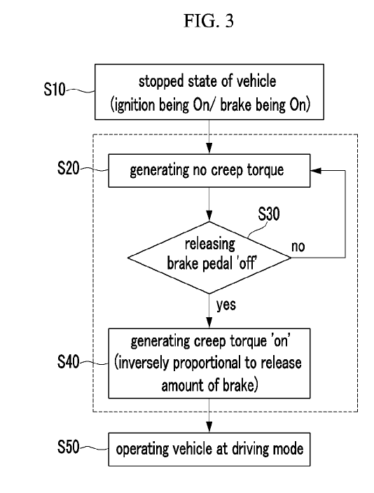

A method for controlling creep torque of a vehicle according to an exemplary embodiment of the present invention will be described in detail with reference to FIG. 3 and FIG. 4.

Although the above exemplary embodiment is described as using a single control portion to perform the above process, it is understood that the above processes may also be performed by a plurality of control portions, controllers, processors or the like.

Furthermore, the control logic (of the control portion) of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

FIG. 3 is a flowchart of a method for controlling creep torque of a vehicle according to an exemplary embodiment of the present invention, and FIG. 4 is a graph for illustrating relation of an input of a brake pedal and creep torque in a system and a method for controlling creep torque of a vehicle according to an exemplary embodiment of the present invention.

As shown in FIG. 3, a method for controlling creep torque of a vehicle according to an exemplary embodiment of the present invention includes detecting, by a sensor, that brakes of the vehicle are being applied while the vehicle is moving at step S10, controlling, by the control portion, the creep torque to be 0 once the vehicle has been stopped by operation of the brakes at step S20, determining, by the control portion, whether the brakes have been released at step S30, sending a command to an motor to generate creep torque once the brakes have been released at step S40, and operating the vehicle in a driving mode when the creep torque is generated at step S50.

The exemplary embodiment of the present invention is configured to reduce creep groan noise due to stick-slip when the vehicle runs with lower speed by releasing the brake. Therefore, the method according to an exemplary embodiment of the present invention is started when the vehicle is stopped by operating the brake. Since the vehicle should generate the creep torque when the brake is released, ignition of the vehicle should be On-state.

When the brake is operated, the ignition of the vehicle is the On-state, and the vehicle is stopped, the control portion 300 controls the creep torque of the vehicle to be 0 at the step S20. That is, the creep torque of the vehicle is suppressed.

In one or more exemplary embodiments, the vehicle to which the method according to an exemplary embodiment of the present invention is applied may be the electric vehicle or the hybrid electric vehicle. When the vehicle to which the method according to an exemplary embodiment of the present invention is applied is the hybrid electric vehicle, the method according to an exemplary embodiment of the present invention is used only at the electric vehicle mode.

After that, the control portion 300 determines whether the brake of the vehicle is released at the step S30. The control portion 300 of the vehicle such as the ECU receives the signal of the sensor which detects whether the brake is operated and determines whether the brake is operated or released.

In one or more exemplary embodiments, the sensor may be the brake pedal sensor 100. When the driver pushes the brake pedal, the brake pedal sensor 100 detects pushed degree of the brake pedal and delivers the signal corresponding thereto to the control portion 300, and the control portion 300 determines whether the brake has been applied. When the driver takes his foot off the brake pedal, the brake pedal sensor 100 detects the movement and delivers the signal corresponding thereto to the control portion 300, and the control portion 300 determines that the brakes have released.

In one or more exemplary embodiments, how much the driver pushes the brake pedal may be utilized as a threshold for whether the brakes are being applied and how much the driver releases the brake pedal may be utilized as a threshold for whether the brakes have been released and accordingly a preset for each of these thresholds may be stored in the control portion 300. That is, the brakes may be determined to be released when the signal delivered from the brake pedal sensor 100 is less than or equal to a predetermined value and the brakes may be determined to be applied when the signal delivered from the brake pedal sensor 100 is greater than the predetermined value.

In addition, the control portion 300 considers a point at which the input of the brake detected by a brake pedal simulator or the brake pedal sensor 100 drops rapidly as a release point of the brake, as shown in FIG. 4. When it is determined at the step S30 that the brake is not released, the control portion 300 returns to the step S20. Therefore, the creep torque is maintained to be 0 until the brake is released.

On the contrary, when it is determined at the step S30 that the brake has been released, the control portion 300 sends a command to the electric motor to generate the creep torque of the vehicle at the step S40. That is, the electric motor 200 is controlled not to generate the creep torque when the brakes have been applied, and generates a creep torque once the brakes are released. Therefore, stick-slip may be minimized

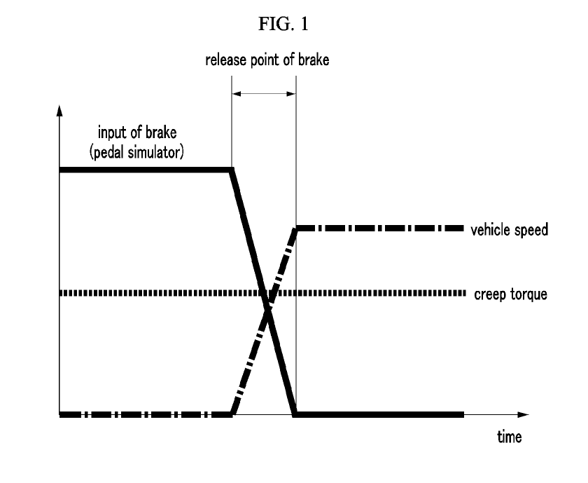

Even when the brakes are operated, creep torque is being generated in a conventional art. Accordingly, when the brakes are released, stick-slip occurs within a region when the creep torque is greater than the brake torque and creep groan noise is greatly produced, as shown in FIG. 1.

According to an exemplary embodiment of the present invention, however, the creep torque is controlled to be 0 when the brakes are applied and the creep torque is again generated when the brakes are released. Therefore, stick-slip may be minimized Additionally, creep groan noise as a result may be greatly reduced due to minimization of stick-slip according to an exemplary embodiment of the present invention.

In one or more exemplary embodiments, the control portion 300 may control the electric motor 200 to generate the creep torque inversely proportional to release amount of the brake, as shown in FIG. 4.

Since the control portion 300 receives the input of the brake pedal from the brake pedal sensor 100 in real time, the control portion 300 sends a command to the electric motor to generate creep torque inversely proportional to the input of the brake pedal. Therefore, “take off” feel and driving safety of the vehicle may be improved when the vehicle begins to move again.

Additionally, as stated above, when the creep torque is generated, the vehicle is operated at the driving mode at the step S50. Since the creep torque of the vehicle is generated inversely proportional to the release amount of the brake, the vehicle may begin to move slowly and “take off” and driving safety of the vehicle may be improved.

Further, since the creep torque is not generated when the brakes are applied and are only generated once the brakes have been released, stick-slip may be minimized and creep groan noise of the vehicle may be greatly reduced according to an exemplary embodiment of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for controlling creep torque of a vehicle, comprising:
detecting, by a sensor, that brakes of the vehicle are being applied;
controlling, by a control portion, creep torque to be 0 once the vehicle has come to a stop based on an input signal from the sensor that the brakes are being applied;
determining, by the control portion, whether the brakes have been released; and
generating creep torque again once the brakes have been released.

2. The method of claim 1, further comprising operating the vehicle in a driving mode while creep torque is being generated.

3. The method of claim 1, wherein the creep torque is generated inversely proportional to a release amount of a brake pedal.

4. The method of claim 1, wherein the vehicle is an electric vehicle.

5. The method of claim 1, wherein the vehicle is a hybrid electric vehicle and the hybrid electric vehicle operates in an electric vehicle mode while creep torque is being applied.

6. The method of claim 4, wherein the electric vehicle is provided with a drive motor, and
wherein the creep torque is generated by controlling torque of the drive motor.

7. The method of claim 5, wherein the hybrid electric vehicle is provided with a drive motor, and
wherein the creep torque is generated by controlling torque of the drive motor.

8. The method of claim 1, wherein operation and release of the brakes is detected by a brake pedal sensor.

9. A system for controlling creep torque of a vehicle, comprising:
a sensor configured to detect an input of a brake pedal of the vehicle and delivering a signal corresponding thereto;
an electric motor configured to generate the creep torque of the vehicle; and
a control portion configured to receive an input signal from the sensor and to control the electric motor based thereon,
wherein the control portion is configured to control creep torque to be 0 when the brake pedal is applied, and to control the electric motor to generate creep torque once the brake is released.

10. The system of claim 9, wherein the control portion is configured to generate creep inversely proportional to a release amount of the brake pedal.

11. The system of claim 9, wherein the sensor is a brake pedal sensor.

12. The system of claim 9, wherein the vehicle is an electric vehicle or a hybrid electric vehicle.

13. A non-transitory computer readable medium containing program instructions executed by a processor or controller, the computer readable medium comprising:
program instructions that control creep torque to be 0 once a vehicle has come to a stop based on an input signal from a brake sensor that brakes are being applied;
program instructions that determine whether the brakes have been released; and
program instructions that send a control command to an electric motor to generate creep torque again once the brakes have been released.

14. The method of claim 13, further comprising program instructions that operate the vehicle in a driving mode while creep torque is being generated.

15. The method of claim 13, wherein the creep torque is generated inversely proportional to a release amount of a brake pedal.

16. The method of claim 13, wherein the vehicle is an electric vehicle.

17. The method of claim 13, wherein the vehicle is a hybrid electric vehicle and program instructions operate in an electric vehicle mode while creep torque is being applied.

18. The method of claim 17, wherein creep torque is generated by controlling torque of a drive motor.

19. The method of claim 13, wherein operation and release of the brakes is detected by a brake pedal sensor.
